(19) United States
(12) Patent Application Publication
(10) Pub. No.: US 2025/0074439 A1
(43) Pub. Date: Mar. 6, 2025

(54) METHOD FOR DEVELOPING AUTONOMOUS DRIVING VEHICLE

(71) Applicant: TOYOTA JIDOSHA KABUSHIKI KAISHA, Toyota-shi Aichi-ken (JP)

(72) Inventor: Wataru KAWASHIMA, Nisshin-shi Aichi (JP)

(73) Assignee: TOYOTA JIDOSHA KABUSHIKI KAISHA, Toyota-shi Aichi-ken (JP)

(21) Appl. No.: 18/813,951

(22) Filed: Aug. 23, 2024

(30) Foreign Application Priority Data
Aug. 30, 2023 (JP) 2023-140259

(51) Int. Cl. B60W 50/06; B60W 60/00; G06N 20/00

(52) U.S. Cl. CPC B60W 50/06; B60W 60/001; G06N 20/00

(57) ABSTRACT

A method for developing an autonomous driving vehicle including an external sensor including a number, a type, and a detection performance as a sensor specification, wherein the autonomous driving vehicle includes a machine learning model to configured to output a route with respect to at least a recognition process and a planning process to plan the route among the recognition process, the planning process, and a vehicle control process, the method comprising: a first step of training the machine learning model by adapting at least the recognition process and the planning process using a first autonomous driving vehicle including the external sensor having a first sensor specification; and a second step of applying the machine learning model trained in the first step to a second autonomous driving vehicle including the external sensor having a second sensor specification that is inferior to the first sensor specification.

### CROSS-REFERENCE TO RELATED APPLICATION

This application claims the benefit of priority from Japanese Patent Application No. 2023-140259, filed on Aug. 30, 2023, the entire contents of which are incorporated herein by reference.

### TECHNICAL FIELD

The present disclosure relates to a method for developing an autonomous driving vehicle.

### BACKGROUND

A detection system described in Japanese Unexamined Patent Publication No. 2022-082510 includes an analysis module in the form of a convolutional neural network. An image from a camera and sensor data from a sensor device are used as input data for the analysis module, and are analyzed in real time by the detection system. As a result of the analysis, for example, a safety level of a second vehicle is indicated from the movement of a vehicle body of a first vehicle traveling in front of the second vehicle, and at least one of an optical alarm and an acoustic alarm is output on a user interface of the second vehicle depending on the safety level.

In an autonomous driving vehicle that recognizes an external environment based on detection results of external sensors to plan a route, and that performs autonomous driving control based on the planned route, input data for the route plan changes depending on, for example, the number, the types, and the detection performances of the external sensors. For this reason, in the related art, the result of adapting the route plan cannot be simply used between autonomous driving vehicles including external sensors with different configurations, and route plans need to be separately re-adapted according to different input data. As a result, a huge amount of development man-hours are required.

The present disclosure describes reducing the effort of re-adapting a second autonomous driving vehicle having a second sensor specification, which is inferior to a first sensor specification in at least one of a number, a type, and a detection performance, separately from a first autonomous driving vehicle.

### SUMMARY

One aspect of the present disclosure is a method for developing an autonomous driving vehicle including an external sensor including a number, a type, and a detection performance as a sensor specification, in which the autonomous driving vehicle includes an autonomous driving system configured to apply a machine learning model to at least a recognition process to recognize an external environment based on a detection result of the external sensor and a planning process to plan a route using a result of the recognition process among the recognition process, the planning process, and a vehicle control process to perform autonomous driving control based on the planned route, the machine learning model being configured to output the route by taking the detection result of the external sensor as an input, the method including: a first step of training the machine learning model by adapting at least the recognition process and the planning process using a first autonomous driving vehicle including the external sensor having a first sensor specification; and a second step of applying the machine learning model trained in the first step to a second autonomous driving vehicle including the external sensor having a second sensor specification that is inferior to the first sensor specification in at least one of the number, the type, and the detection performance.

In the method for developing an autonomous driving vehicle according to one aspect of the present disclosure, in the first step, the machine learning model is trained using the first autonomous driving vehicle having the sensor specification superior to the sensor specification of the second autonomous driving vehicle. In the second step, the machine learning model trained on the first autonomous driving vehicle is applied to the second autonomous driving vehicle.

Accordingly, in the second autonomous driving vehicle, a route equivalent to a route of the first autonomous driving vehicle can be output using the trained machine learning model. Therefore, it is possible to reduce the effort of re-adapting the second autonomous driving vehicle having the second sensor specification, which is inferior to the first sensor specification in at least one of the number, the type, and the detection performance, separately from the first autonomous driving vehicle.

In the method for developing an autonomous driving vehicle according to one embodiment, the autonomous driving system may apply the machine learning model to the recognition process, the planning process, and the vehicle control process, the machine learning model being configured to output a control amount of the autonomous driving control by taking the detection result of the external sensor as an input. In the first step, the machine learning model may be trained by adapting the recognition process, the planning process, and the vehicle control process using the first autonomous driving vehicle.

According to the present disclosure, it is possible to reduce the effort of re-adapting the second autonomous driving vehicle having the second sensor specification, which is inferior to the first sensor specification in at least one of the number, the type, and the detection performance, separately from the first autonomous driving vehicle.

### BRIEF DESCRIPTION OF THE DRAWINGS

FIG. 1 is a block diagram illustrating an autonomous driving vehicle used to train machine learning models in a method for developing an autonomous driving vehicle according to an embodiment.

FIG. 2 is a block diagram illustrating an autonomous driving vehicle to which the trained machine learning models are applied in the method for developing an autonomous driving vehicle according to the embodiment.

FIG. 3 is a flowchart illustrating a procedure of the method for developing an autonomous driving vehicle according to the embodiment.

### DETAILED DESCRIPTION

Hereinafter, an exemplary embodiment will be described with reference to the drawings. In the following description, the same or equivalent elements are denoted by the same reference signs, and duplicate descriptions may be omitted.

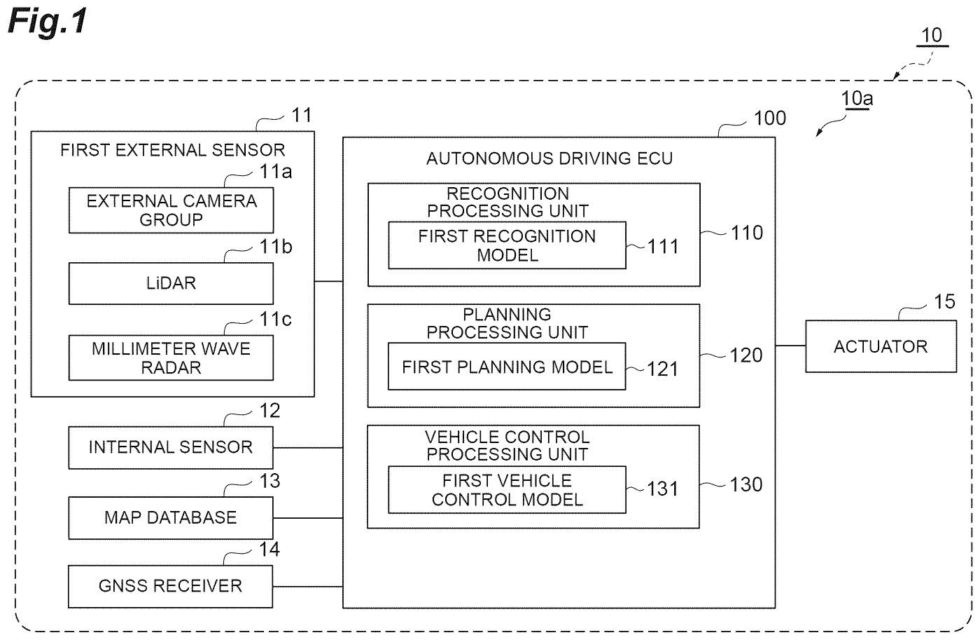

FIG. 1 is a block diagram illustrating an autonomous driving vehicle used to train machine learning models in a method for developing an autonomous driving vehicle according to an embodiment. As shown in FIG. 1, an autonomous driving vehicle 10 is, for example, a vehicle such as a passenger car. The autonomous driving vehicle 10 includes an autonomous driving system 10a that causes the autonomous driving vehicle 10 to travel in an autonomous driving mode. The autonomous driving system 10a may be installed in the autonomous driving vehicle 10, or may have a mode in which some functions are executed by a server capable of communicating with the autonomous driving vehicle 10.

The autonomous driving system 10a of the autonomous driving vehicle 10 includes a first external sensor (external sensor) 11, an internal sensor 12, a map database 13, a GNSS receiver 14, an actuator 15, and an autonomous driving electronic control unit (ECU) 100.

The first external sensor 11 is a detection device that detects a surrounding situation (external environment) of the autonomous driving vehicle 10. A sensor specification (first sensor specification) of the first external sensor 11 is, for example, the highest-level sensor specification of the manufacturer of the autonomous driving vehicle 10. The sensor specification includes the number, types, and detection performances of external sensors.

The first external sensor 11 includes an external camera group 11a that captures at least an image of a region in front of the autonomous driving vehicle 10. The first external sensor 11 may include a radar sensor. The first external sensor 11 may be configured to be able to reconstruct properties of the external environment of the vehicle in which the autonomous driving vehicle 10 travels (the position of the vehicle, relative distances to other vehicles, relative speeds to other vehicles, the directions of other vehicles, the shapes of lanes, the lighting states of traffic lights, and the like).

The external camera group 11a is an imaging device that captures an image of the external environment of the autonomous driving vehicle 10. The external camera group 11a includes a plurality of cameras of different types and with different detection performances. Examples of the types of the external camera group 11a include a telephoto camera, a wide-angle camera, a monocular camera, and a stereo camera.

Examples of the detection performance of the external camera group 11a include resolution and nighttime image quality, and so on. The stereo camera includes two imaging units arranged to reproduce a binocular parallax. Imaging information of the stereo camera also includes information in a depth direction. The external camera group 11a transmits imaging information regarding the external environment of the autonomous driving vehicle 10 to the autonomous driving ECU 100. The external camera group 11a includes, for example, a front camera provided on a back side of a windshield of the autonomous driving vehicle 10. The external camera group 11a may include side cameras provided on door mirrors of the autonomous driving vehicle 10. The external camera group 11a may include a rear camera provided on a rear glass of the autonomous driving vehicle 10. The external camera group 11a may also include a camera that captures an image of the external environment of the autonomous driving vehicle 10 for use in autonomous driving.

The radar sensor is a detection device that detects an object around the autonomous driving vehicle 10 using at least one of radio waves (for example, millimeter waves) and light. The radar sensor detects an object by transmitting at least one of radio waves and light to the surroundings of the autonomous driving vehicle 10 and receiving at least one of the radio waves and light reflected by the object. The radar sensor transmits detected object information to the autonomous driving ECU 100.

The radar sensor includes a plurality of radar sensors of different types and different detection performances. Examples of the type of the radar sensor include a light detection and ranging (LiDAR) and a millimeter wave radar. Examples of the detection performance of the radar sensor include resolution and measurable distance. The radar sensor referred to here includes, for example, a LiDAR 11b and a millimeter wave radar 11c.

The internal sensor 12 is a detection device that detects the traveling state of the autonomous driving vehicle 10. The internal sensor 12 includes a vehicle speed sensor. The vehicle speed sensor is a detector that detects a speed of the autonomous driving vehicle 10. As the vehicle speed sensor, for example, a known wheel speed sensor may be used. The vehicle speed sensor transmits detected vehicle speed information to the autonomous driving ECU 100.

The internal sensor 12 may include a known acceleration sensor and a known yaw rate sensor. The acceleration sensor is a detector that detects an acceleration of the autonomous driving vehicle 10. The acceleration sensor transmits acceleration information of the autonomous driving vehicle 10 to the autonomous driving ECU 100. The yaw rate sensor is a detector (for example, gyro sensor) that detects a yaw rate (rotational angular speed) around a vertical axis of the center of gravity of the autonomous driving vehicle 10. The yaw rate sensor transmits detected yaw rate information of the vehicle to the autonomous driving ECU 100.

The map database 13 is a storage device that stores map information. The map database 13 is formed in, for example, a storage medium such as a hard disk drive (HDD) installed in the autonomous driving vehicle 10. The map information includes information on the positions, shapes, and the like of roads, intersections, branching points, and the like (for example, the positions and shapes of intersections, the widths of lanes, the positions of lane markings and pedestrian crossings, and the like). The map information may also include information on structures (the positions, types, and the like of traffic lights at intersections) and various types of traffic rule information (information on one-way traffic, no right or left turns, no U-turns, and the like). A part of the map information included in the map database 13 may be stored in a storage device other than an HDD or the like. The map database 13 may be formed on a computer in a facility such as a management center capable of communicating with the autonomous driving vehicle 10.

The GNSS receiver 14 measures a position of a host vehicle (for example, the latitude and longitude of the host vehicle) by receiving signals from positioning satellites. The GNSS receiver 14 transmits measured position information of the host vehicle to the autonomous driving ECU 100.

The actuator 15 is a device used for autonomous driving control of autonomous driving vehicle 10. The actuator 15 includes at least a drive actuator, a brake actuator, and a steering actuator. For example, the drive actuator controls the amount of supply of air (throttle opening degree) to an engine in response to a control signal from the autonomous driving ECU 100, and controls a driving force of the autonomous driving vehicle 10. When the autonomous driving vehicle 10 is a hybrid vehicle, in addition to the amount of supply of air to the engine, a control signal from the autonomous driving ECU 100 is input to a motor serving as a power source to control the driving force. When the autonomous driving vehicle 10 is an electric vehicle, a control signal from the autonomous driving ECU 100 is input to a motor serving as a power source to control the driving force. In these cases, the motor serving as a power source constitutes the actuator 15.

The brake actuator controls a brake system in response to a control signal from the autonomous driving ECU 100, and controls a braking force applied to wheels of the autonomous driving vehicle 10. As the brake system, for example, a hydraulic brake system can be used. The steering actuator controls the driving of an assist motor, which controls a steering torque of an electric power steering system, in response to a control signal from the autonomous driving ECU 100. Accordingly, the steering actuator controls the steering torque in response to a control signal from the autonomous driving ECU 100.

The autonomous driving ECU 100 is a main component of the autonomous driving system 10a. The autonomous driving ECU 100 executes autonomous driving control of the autonomous driving vehicle 10. The autonomous driving ECU 100 is an electronic control unit including a central processing unit (CPU), a read only memory (ROM), a random access memory (RAM), a controller area network (CAN) communication circuit, and the like. The autonomous driving ECU 100 is connected to, for example, a network that performs communication using the CAN communication circuit, and is communicably connected to the above-described components of the autonomous driving vehicle 10.

The autonomous driving ECU 100 realizes an autonomous driving function, for example, by operating the CAN communication circuit to input and output data based on a signal output by the CPU, storing the data in the RAM, loading a program stored in the ROM into the RAM, and causing the CPU to execute the program loaded into the RAM. The autonomous driving ECU 100 may be made up of a plurality of electronic units.

Next, one example of functional configurations of the autonomous driving ECU 100 will be described. The autonomous driving ECU 100 includes a recognition processing unit 110, a planning processing unit 120, and a vehicle control processing unit 130.

The autonomous driving system 10a is configured to be able to execute a recognition process, a planning process, and a vehicle control process. The recognition process is a process of recognizing the external environment based on the detection results of the external sensors mounted in the autonomous driving vehicle 10. The planning process is a process of planning a route using a result of the recognition process. The vehicle control process is a process of performing autonomous driving control based on a planned route.

In the autonomous driving system 10a, as one example, a machine learning model is applied to each of the recognition process, the planning process, and the vehicle control process. The machine learning model referred to here includes a first recognition model 111 of the recognition processing unit 110, a first planning model 121 of the planning processing unit 120, and a first vehicle control model 131 of the vehicle control processing unit 130.

The recognition processing unit 110 performs the recognition process based on the detection result of the first external sensor 11 using the first recognition model 111. The first recognition model 111 is, for example, a machine learning model in which learning is performed using deep learning to recognize objects (for example, other vehicles, traffic lights, and the like) from images captured by the external camera group 11a, and a machine learning model in which machine learning (for example, deep learning) is performed to recognize objects (for example, lane markings and the like) from the detection result of the radar sensor. A neural network constituting the first recognition model 111 is, for example, a convolutional neural network (CNN) including a plurality of layers including a plurality of convolutional layers and pooling layers. The neural network may further be configured as a recurrent neural network (RNN). The recognition processing unit 110 acquires an object recognition result output from the first recognition model 111 by inputting the detection result of the first external sensor 11 to the first recognition model 111.

The recognition processing unit 110 recognizes the external environment of the autonomous driving vehicle 10 based on the object recognition result output from the first recognition model 111. The external environment includes the relative positions of surrounding objects with respect to the autonomous driving vehicle 10. The external environment may include the relative speeds and the movement directions of the surrounding objects with respect to the autonomous driving vehicle 10.

The recognition processing unit 110 recognizes the traveling state of the autonomous driving vehicle 10 based on the detection result of the internal sensor 12. The traveling state includes, for example, the vehicle speed of the autonomous driving vehicle 10, the acceleration of the autonomous driving vehicle 10, and the yaw rate of the autonomous driving vehicle 10. The recognition processing unit 110 acquires, for example, a road environment (for example, the shapes of roads, the shapes of intersections, the types of traffic signals, and the like) around the autonomous driving vehicle 10 based on the map information.

The recognition processing unit 110 acquires a current vehicle position of the autonomous driving vehicle 10, for example, based on position information from the GNSS receiver 14. The recognition processing unit 110 may acquire the current vehicle position of the autonomous driving vehicle 10 using the SLAM technique. The recognition processing unit 110 may also acquire the current vehicle position of the autonomous driving vehicle 10 using a known technique.

The planning processing unit 120 generates a route plan using the first planning model 121. The first planning model 121 is, for example, a machine learning model in which machine learning (for example, deep learning) is performed to output a route plan based on the object recognition result, a target route, the current vehicle position of the autonomous driving vehicle 10, and the traveling state of the autonomous driving vehicle 10 output from the first recognition model 111. A neural network constituting the first planning model 121 may be a convolutional neural network or may be a recurrent neural network. The neural network constituting the first planning model 121 may be of the same type as the first recognition model 111, or may be of a different type from the first recognition model 111.

The route plan is a plan regarding a route along which the autonomous driving vehicle 10 travels. The route plan is used in the autonomous driving of the autonomous driving vehicle 10. The route plan may be consecutive coordinate data on a map. The route plan may be data including a target lateral position of a traveling lane (control target position in a width direction of the traveling lane) with respect to a target longitudinal position (control target position in an extending direction of the traveling lane). The route plan may be data including a target steering angle for the target longitudinal position of the traveling lane. The route plan may be at least one of time series data of the target lateral position and time series data of the target steering angle with respect to the lane. In the route plan, a target steering torque may be used instead of the target steering angle.

The vehicle control processing unit 130 may perform vehicle control using the first vehicle control model 131. The first vehicle control model 131 is, for example, a machine learning model in which machine learning (for example, deep learning) is performed to output a control amount of autonomous driving control for causing the autonomous driving vehicle 10 to travel autonomously according to the route plan based on the route plan output from the first planning model 121 and the traveling state of the autonomous driving vehicle 10. A neural network constituting the first vehicle control model 131 may be a convolutional neural network or may be a recurrent neural network. The neural network constituting the first vehicle control model 131 may be of the same type as at least one of the first recognition model 111 and the first planning model 121. The neural network constituting the first vehicle control model 131 may be a different type of neural network from the first recognition model 111 and the first planning model 121. The control amount of the autonomous driving control can be, for example, data on the steering angle and the vehicle speed (a steering angle plan and a vehicle speed plan) of the autonomous driving vehicle 10 set at predetermined intervals on the target route. The vehicle control processing unit 130 controls the actuator 15 to follow the route plan output from the first planning model 121, and executes autonomous driving of the autonomous driving vehicle 10.

Generally, the lower the level of assistance of the autonomous driving control is, the more easily inexpensive external sensors are used. Conversely, the higher the level of assistance is, the more expensive external sensors tend to be used or the number of the external sensors tends to be increased. When the configurations of the external sensors are different in such a manner, in the related art, a system with a high level of assistance cannot be necessarily used. For this reason, even when the development of an autonomous driving system with a higher level of assistance is completed in advance, an autonomous driving system with a lower level of assistance may be separately developed. As a result, development cost may increase.

Therefore, in the method for developing an autonomous driving vehicle according to the present embodiment, the first recognition model 111, the first planning model 121, and the first vehicle control model 131 are applicable to an autonomous driving vehicle 20 including a second external sensor 21. The first recognition model 111, the first planning model 121, and the first vehicle control model 131 are trained using the autonomous driving vehicle 10 including the first external sensor 11.

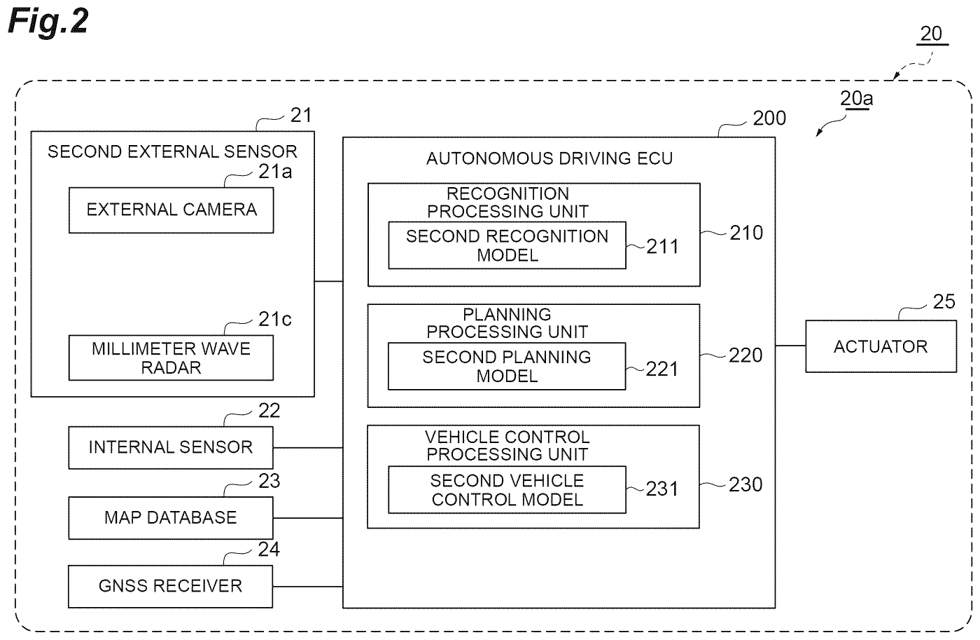

FIG. 2 is a block diagram illustrating an autonomous driving vehicle to which the trained machine learning models are applied in the method for developing an autonomous driving vehicle according to the embodiment. As shown in FIG. 2, the autonomous driving vehicle 20 includes a similar configuration to the autonomous driving vehicle 10. The autonomous driving vehicle 20 is, for example, a vehicle such as a passenger car, and includes an autonomous driving system 20a that causes the autonomous driving vehicle 20 to travel in an autonomous driving mode.

The autonomous driving system 20a of the autonomous driving vehicle 20 includes a second external sensor (external sensor) 21, an internal sensor 22, a map database 23, a GNSS receiver 24, an actuator 25, and an autonomous driving ECU 200.

A sensor specification (second sensor specification) of the autonomous driving system 20a is inferior to the first sensor specification in at least one of the number, the type, and the detection performance. “Being inferior” in terms of the number means that the number is small. “Being inferior” in terms of the type means that an external sensor has a simpler structure among external sensors having different structures. “Being inferior” in terms of the detection performance means, for example, that the detection performance is further suppressed among external sensors having a common structure. “Being inferior” in terms of the detection performance may mean that the detection performance is further suppressed among external sensors having different structures.

The second external sensor 21 includes, for example, an external camera 21a and a millimeter wave radar 21c. The external camera 21a may have, for example, a sensor specification in which the number of cameras is made smaller than that in the external camera group 11a by omitting some of the cameras from the external camera group 11a. In this case, the external camera 21a may have the same sensor specification as some of the cameras included in the external camera group 11a.

In the second external sensor 21, a LiDAR is omitted from the radar sensor. The millimeter wave radar 21c may have the same number, type, and detection performance as the millimeter wave radar 11c.

In the autonomous driving system 20a, the components (the internal sensor 22, the map database 23, the GNSS receiver 24, and the actuator 25) other than the second external sensor 21 may be configured basically in the same manner.

In the autonomous driving system 20a, the autonomous driving ECU 200 includes a recognition processing unit 210, a planning processing unit 220, and a vehicle control processing unit 230. In the autonomous driving system 20a, for example, a second recognition model 211, a second planning model 221, and a second vehicle control model 231 can also be regarded as an integrated machine learning model unit that outputs a route by taking a detection result of the second external sensor 21 as an input, and that performs vehicle control.

As the second recognition model 211 of the recognition processing unit 210, the first recognition model 111 trained in the autonomous driving system 10a is applied. In this case, instead of the cameras having the same specification as the external camera 21a among the cameras included in the external camera group 11a, the external camera 21a can be used as an input to the first recognition model 111 trained in the autonomous driving system 10a. In addition, as an input to the first recognition model 111 trained in the autonomous driving system 10a, there can be no input from the LiDAR.

The recognition processing unit 210 acquires an object recognition result output from the second recognition model 211 by inputting the detection result of the second external sensor 21 to the second recognition model 211. Since the acquisition result is the same as the result of inputting the detection result of the second external sensor 21 to the first recognition model 111, the effort of adaptation in the second recognition model 211 is eliminated.

As the second planning model 221 of the planning processing unit 220, the first planning model 121 trained in the autonomous driving system 10a is applied. A difference in the specification of the second external sensor 21 is adjusted when it is input to the second recognition model 211. For this reason, the second planning model 221 can output a route plan for the autonomous driving vehicle 20 based on the object recognition result, a target route, a current vehicle position of the autonomous driving vehicle 20, and the traveling state of the autonomous driving vehicle 20 output from the second recognition model 211.

The vehicle control processing unit 230 may perform vehicle control using the second vehicle control model 231. The second vehicle control model 231 may be the first vehicle control model 131 trained in the autonomous driving system 10a. The vehicle control processing unit 230 causes the autonomous driving vehicle 20 to travel autonomously according to the route plan of the autonomous driving vehicle 20, for example, based on the route plan output from the second planning model 221 and the traveling state of the autonomous driving vehicle 20.

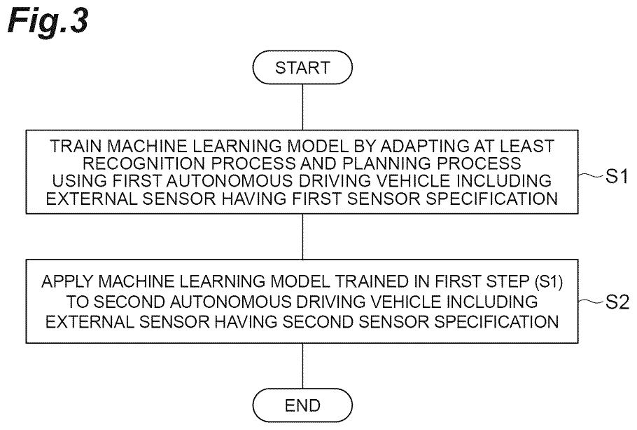

Next, a procedure of the method for developing an autonomous driving vehicle will be described with reference to FIG. 3. FIG. 3 is a flowchart illustrating a procedure of the method for developing an autonomous driving vehicle according to the embodiment. A flowchart shown in FIG. 3 can be executed, for example, when the autonomous driving vehicle 10 is developed in advance, and the autonomous driving vehicle 20 is developed in parallel with the development or after the development.

As shown in FIG. 3, in the method for developing an autonomous driving vehicle according to the embodiment, in S1 (first step), the machine learning models are trained by adapting at least the recognition process and the planning process using a first autonomous driving vehicle including an external sensor having the first sensor specification. In the present embodiment, for example, the first recognition model 111 and the first planning model 121 are trained by adapting the recognition process and the planning process using the autonomous driving vehicle 10 including the first external sensor 11 including the external camera group 11a, the LiDAR 11b, and the millimeter wave radar 11c.

In S2 (second step), the machine learning models trained in the first step are applied to a second autonomous driving vehicle including an external sensor having the second sensor specification. In the present embodiment, for example, the first recognition model 111 and the first planning model 121 trained in step S1 are applied to the autonomous driving vehicle 20 including the second external sensor 21 including the external camera 21a and the millimeter wave radar 21c. Thereafter, the procedure of FIG. 3 ends.

As described above, in the method for developing an autonomous driving vehicle according to the embodiment, in step S1, at least the first recognition model 111 and the first planning model 121 are trained using the autonomous driving vehicle 10 having a sensor specification superior to that of the autonomous driving vehicle 20. In step S2, the first recognition model 111 and the first planning model 121 trained on the autonomous driving vehicle 10 are applied to the autonomous driving vehicle 20. Accordingly, in the autonomous driving vehicle 20, a route equivalent to that of the autonomous driving vehicle 10 can be output using the first recognition model 111 and the first planning model 121 that are trained. Therefore, it is possible to reduce the effort of re-adapting the autonomous driving vehicle 20 having the second sensor specification, which is inferior to the first sensor specification in at least one of the number, the type, and the detection performance, separately from the autonomous driving vehicle 10.

In the method for developing an autonomous driving vehicle according to the embodiment, the autonomous driving system 10a applies a machine learning model to the recognition process, the planning process, and the vehicle control process, the machine learning model being configured to output a control amount of autonomous driving control by taking the detection result of the external sensor as an input. In step S1, the first recognition model 111, the first planning model 121, and the first vehicle control model 131 are trained by adapting the recognition process, the planning process, and the vehicle control process using the autonomous driving vehicle 10. According to this configuration, the machine learning model that also includes the vehicle control process is trained on the autonomous driving vehicle 10, and is applied to the autonomous driving vehicle 20. Accordingly, in the autonomous driving vehicle 20, a control amount of autonomous driving control equivalent to that of the autonomous driving vehicle 10 can be output using the first recognition model 111, the first planning model 121, and the first vehicle control model 131, which are trained machine learning models.

According to the method for developing an autonomous driving vehicle according to the embodiment, there is a possibility that performance is improved by not only suppressing the development cost of the autonomous driving vehicle 20 including the autonomous driving system 20a that is cheaper, but also learning the output of the autonomous driving system 10a that is expensive, compared to when the autonomous driving system 20a is independently developed.

### MODIFICATION EXAMPLES

Various exemplary embodiments have been described above; however, various omissions, substitutions, and changes may be made without being limited to the above-described exemplary embodiment.

In the embodiment, the first vehicle control model 131 trained on the autonomous driving vehicle 10 has been applied to the autonomous driving vehicle 20; however, the present disclosure is not limited to this example. The machine learning models may be trained by adapting at least the recognition process and the planning process. In this case, in the autonomous driving system, at least the machine learning model for the recognition process and the machine learning model for the planning process may be regarded as an integrated machine learning model unit that outputs a route by taking the detection result of the external sensor as an input.

In the embodiment, the second external sensor 21 including the external camera 21a and the millimeter wave radar 21c has been illustrated; however, the “second sensor specification that is inferior to the first sensor specification in at least one of the number, the type, and the detection performance” is not limited to this example. For example, when a resolution of the external camera is different from a resolution of all the cameras included in the external camera group 11a, the resolution of the external camera can be used as an input to the machine learning models trained on the autonomous driving system 10a by converting the resolution of the external camera to match the resolution of the cameras included in the external camera group 11a. Alternatively, when an image quality of the external camera is different from an image quality of all the cameras included in the external camera group 11a, an image captured by the external camera 21a can be used as an input to the machine learning models trained on the autonomous driving system 10a by adding noise to the image to match the image quality of the cameras included in the external camera group 11a. The same applies to a resolution and noise of the laser radar.

What is claimed is:

1. A method for developing an autonomous driving vehicle including an external sensor including a number, a type, and a detection performance as a sensor specification, wherein the autonomous driving vehicle includes an autonomous driving system configured to apply a machine learning model to at least a recognition process to recognize an external environment based on a detection result of the external sensor and a planning process to plan a route using a result of the recognition process among the recognition process, the planning process, and a vehicle control process to perform autonomous driving control based on the planned route, the machine learning model being configured to output the route by taking the detection result of the external sensor as an input, the method comprising:
a first step of training the machine learning model by adapting at least the recognition process and the planning process using a first autonomous driving vehicle including the external sensor having a first sensor specification; and
a second step of applying the machine learning model trained in the first step to a second autonomous driving vehicle including the external sensor having a second sensor specification that is inferior to the first sensor specification in at least one of the number, the type, and the detection performance.

2. The method for developing an autonomous driving vehicle according to claim 1,
wherein the autonomous driving system applies the machine learning model to the recognition process, the planning process, and the vehicle control process, the machine learning model being configured to output a control amount of the autonomous driving control by taking the detection result of the external sensor as an input, and
in the first step, the machine learning model is trained by adapting the recognition process, the planning process, and the vehicle control process using the first autonomous driving vehicle.
